(19) United States
(12) Patent Application Publication
(10) Pub. No.: US 2008/0231772 A1
(43) Pub. Date: Sep. 25, 2008

(54) FLAT PANEL DISPLAY AND FABRICATION METHOD THEREOF

(75) Inventor: Chen-Pin Hung, Tainan (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Chi Mei Optoelectronics Corp., Tainan (TW)

(21) Appl. No.: 12/052,123

(22) Filed: Mar. 20, 2008

(30) Foreign Application Priority Data
Mar. 21, 2007 (TW) 096109689

(51) Int. Cl. F21V 13/04; G02F 1/13357

(52) U.S. Cl. 349/65; 362/612; 362/616

(57) ABSTRACT

A flat panel display is provided. The flat panel includes at least one light emitting device having a light emitting semiconductor device and a lens. The lens includes two reflective surfaces which are disposed at both sides with respect to a central axis of the lens. Refractive surfaces connect with the respective reflective surfaces and have a tilt included angle with respect to the central axis. Each of the refractive surfaces continuously extends from the reflective surface along a direction toward the central axis. A Fresnel surface is configured between the refractive surfaces. Light rays emitted from the light emitting semiconductor device reach the lens. A portion of the light rays reaching each of the reflective surfaces is reflected to at least one of the refractive surfaces and the Fresnel surface. The reflected light rays are refracted and collected with a convergent angle.

### CROSS-REFERENCES TO RELATED APPLICATIONS

This application claims the benefit of Taiwan application Serial No. 096109689, filed Mar. 21, 2007, the subject matter of which is incorporated herein by reference.

### BACKGROUND OF THE INVENTION

The present invention generally relates to flat panel displays, and more particularly, to flat panel displays having at least one light emitting device having a small degree divergent angle and fabrication methods thereof.

In recent years, display technologies have been developed significantly. After continuous research and development, products including liquid crystal displays (LCDs), plasma displays, and organic light emitting diode displays (OLED displays) in various sizes have been widely used in various industries. Furthermore, the development of the display technology has been directed toward manufacturing displays having high brightness and high yield for the industry to manufacture the products with more commercial values. Of all components and assemblies of a display, a backlight module used for providing a light source has been one of the vital parts of the display for determining the overall luminous efficiency. If a backlight module has a desired luminous efficiency, the backlight module is capable of effectively increasing the brightness of the display and also expanding the flexibility of designing or manufacturing other associated components of the display. However, if a backlight module cannot provide a desired luminous efficiency, the backlight module cannot provide a desired brightness such that the display cannot provide a desired brightness performance.

Typically, backlight modules can categorized as edge light modules or direct-underlying modules. The backlight module utilizing light emitting diodes (LEDs) as the light source have also become increasingly popular. Furthermore, the backlight modules employing LEDs can provide some merits, such as high detail, high luminosity, and high coloration, mercury-free, and high colorama reproductivity so as to add a liquid crystal panel with more values. Accordingly, the backlight modules having LEDs can overcome technique gateways in future and be applied from portable electronic products to automobiles, displays, televisions and the like. However, when LEDs are utilized as a light source, the illumination direction of the LEDs must be highly paid attention to, so that the backlight module with a desired illumination direction of light beams can provide a desired luminous efficiency and further promote the overall brightness of the display product.

FIG. 1 is a diagram showing a conventional light emitting diode package. As shown in FIG. 1, a light emitting diode package 10 has a packaging substrate 12 and a light emitting diode chip (LED chip) 14. In general, as an electrical current flows through the PN junction of the LED chip 14, electrons can recombine with electron holes to excite light. The light is emitted in different directions and most of the light will be emitted within a divergent angle 16 having a range of ±60°. If the LED package 10 is disposed at a side of a light guide device, the illumination intensity from the divergent angle 16 will be undesired.

FIG. 2 is a diagram showing another conventional LED package. As shown in FIG. 2, a hemispherical lens 32 is disposed on an LED package 30. When a light is emitted from the LED package 30, the produced field of illumination 34 will be spread out along a long axis 36 of the LED package 30 due to the configuration of the hemispherical lens 32. That is, most of the light produced by the LED package 30 is emitted upwards and only a small portion of the light is emitted from two sides of the LED package 30.

FIG. 3 is a diagram showing the LED package of FIG. 2 disposed at a side of a light guide plate (LGP) 38. As shown in FIG. 3, the LED package 30 and a reflector 42 cooperate to direct the propagation direction of the light beams for achieving a desired illumination. Specifically, the reflector 42 is configured to reflect and collimate the light from the hemispherical lens 32 to form a nearly-parallel light 44 before entering the LGP 38. After a series of optical transformations, a uniform and flat light source is provided for the display.

Although the nearly-parallel and uniform light 44 can be produced by the LED package 30 and the reflector 42, the light emitted from the LED package 30 goes through a series of optical medium conversions. After each conversion, a part of the light energy will be absorbed by the medium and transformed into heat in the medium. Accordingly, the illumination of the LED package 30 will be adversely decreased after going through numerous medium conversions. The illumination and promoting the brightness performance of a display product cannot be achieved by the LED package 30.

Therefore, it is desired for the industries to develop a new LED package that not only has a desired divergent angle, but also desirably achieves illumination efficiency by free from going through numerous medium conversion processes.

### BRIEF SUMMARY OF THE INVENTION

Embodiments of the present invention relate to flat panel displays and methods for forming the flat panel displays. The flat panel displays includes at least one light emitting device having a light emitting semiconductor device and a lens covering the light emitting semiconductor device. The lens is configured such that reflected and/or deflected light beams are substantially free from going through medium conversion processes.

Embodiments of the present invention provide a flat panel display. The flat panel display comprises a backlight module, disposed under the display panel. The backlight light module includes a light guide element, at least an optical film disposed over the light guide element, and at least one light emitting device disposed adjacent to a side surface of the light guide element. The light emitting device includes a light emitting semiconductor device and a lens covering the light emitting semiconductor device. The lens includes two reflective surfaces, two refractive surfaces and a Fresnel surface. Each reflective surface is disposed at each side with respect to a central axis of the lens. Each refractive surface connects with one of the reflective surfaces and has a tilt included angle with respect to the central axis. Each refractive surface continuously extends from the reflective surface along a direction toward the central axis. The Fresnel surface is between the refractive surfaces. Light rays emitted from the light emitting semiconductor device reach the lens. A portion of the light rays reaching each of the reflective surfaces is reflected to at least one of the refractive surfaces and the Fresnel surface. The reflected light rays are refracted with a convergent angle.

Embodiments of the present invention provide a flat panel display. The flat panel display includes a display panel and a backlight module disposed under the display panel. The backlight module includes a light guide element, at least an optical film disposed over the light guide element, and at least a light emitting device. The light emitting device includes a circuit board, a light emitting semiconductor device disposed over the circuit board, and a lens covering the light emitting semiconductor device. The lens includes two reflective surfaces, a plurality of refractive surfaces, and an accommodating recess. Each reflective surface is disposed at each side with respect to a central axis of the lens. The refractive surfaces are disposed between the reflective surfaces and respectively have a tilt included angle with respect to the central axis. Two of the refractive surfaces connect with the reflective surfaces and continuously extend from the respective reflective surfaces along a direction toward the central axis. The accommodating recess is configured at the bottom of the lens. The light emitting semiconductor device is configured within the accommodating recess. Light rays emitted from the light emitting semiconductor device reach the lens. A portion of the light rays reaching each reflective surface is reflected to at least one of the refractive surfaces. The reflected light rays are refracted and collected with a convergent angle.

Embodiments of the present invention provide a method for forming a flat panel display. The method includes disposing a backlight module under a display panel. The backlight module includes at least one light emitting device. The light emitting device includes a light emitting semiconductor device and a lens covering the light emitting semiconductor device. The lens includes two reflective surfaces, two refractive surfaces, and a Fresnel surface. Each reflective surface is disposed at each side with respect to a central axis of the lens. Each refractive surface connects with one of the reflective surfaces and has a tilt included angle with respect to the central axis. Each refractive surface continuously extends from the reflective surface along a direction toward the central axis. The Fresnel surface is configured between the refractive surfaces. Light rays emitted from the light emitting semiconductor device reach the lens. A portion of the light rays reaching each of the reflective surfaces is reflected to at least one of the refractive surfaces and the Fresnel surface. The reflected light rays are refracted with a convergent angle.

The present invention enables the light rays emitted from the light emitting semiconductor device collected within a convergent angle by design so as to make the divergent angle of the light rays provided by the light emitting device smaller. Therefore, the backlight module employing the light emitting device of the present invention has better optical usage efficiency, and thereby the present invention can provide the display panel with a high-luminance backlight module and promote the brightness performance of the flat panel display thereof.

### BRIEF DESCRIPTION OF THE DRAWINGS

The accompanying drawings are included to provide a further understanding of the invention, and are incorporated in and provide a part of this specification. The drawings illustrate embodiments of the invention and, together with the description, serve to explain the principles of the invention.

FIG. 1 is a diagram showing a conventional light emitting diode package.

FIG. 2 is a diagram showing another conventional light emitting diode package.

FIG. 3 is a diagram showing the light emitting diode package of FIG. 2 disposed at a side of a light guide plate.

FIG. 4 is a simplified diagram of a light emitting device according to the first embodiment of the present invention.

FIG. 5 is a simplified diagram illustrating a convergent angle of the light emitting device shown in FIG. 4.

FIG. 6 is a simplified exploded diagram of a light emitting device according to the second embodiment of the present invention.

FIG. 7 is a simplified exploded diagram of another light emitting device according to the second embodiment of the present invention.

FIG. 8 is a simplified 3-D diagram of another lens according to the second embodiment of the present invention.

FIG. 9 is a simplified exploded diagram of a light emitting device according to the third embodiment of the present invention.

FIG. 10 is a simplified exploded diagram of a light emitting device according to the fourth embodiment of the present invention.

FIG. 11 is a simplified exploded diagram of a light emitting device according to the fifth embodiment of the present invention.

FIG. 12 is a simplified diagram of a backlight module according to the sixth embodiment of the present invention.

FIG. 13 is a simplified diagram of a backlight module according to the seventh embodiment of the present invention.

FIG. 14 is a simplified diagram of a backlight module according to the eighth embodiment of the present invention.

FIG. 15 is a simplified diagram of a backlight module according to the ninth embodiment of the present invention.

FIG. 16 is a simplified diagram of a flat panel display according to the tenth embodiment of the present invention.

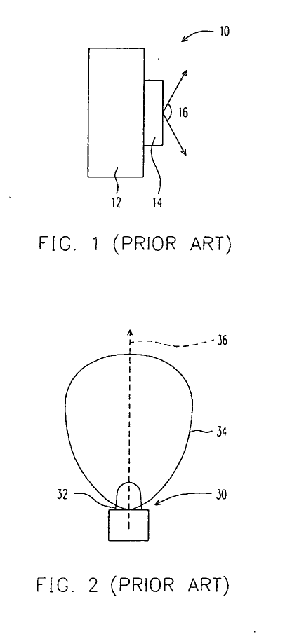

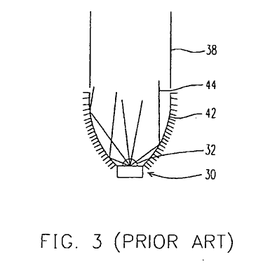

### DETAILED DESCRIPTION OF THE INVENTION

Reference will now be made in detail to the present preferred embodiments of the invention, examples of which are illustrated in the accompanying drawings. Wherever possible, the same reference numbers are used in the drawings and the description to refer to the same or like parts.

Embodiments of the present invention relate to flat panel displays and methods for forming the flat panel displays. The flat panel displays includes at least one light emitting device having a light emitting semiconductor device and a lens covering the light emitting semiconductor device. The lens is configured such that reflected and/or deflected light beams are substantially free from going through medium conversion processes.

### The First Embodiment

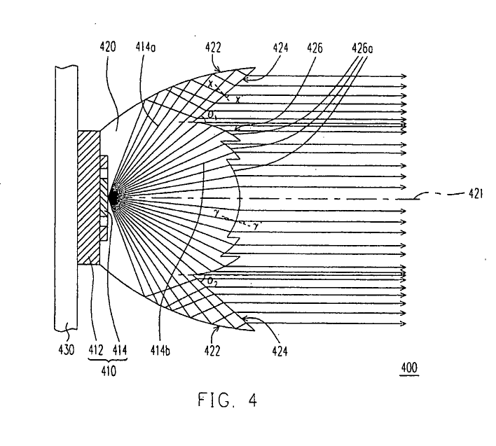

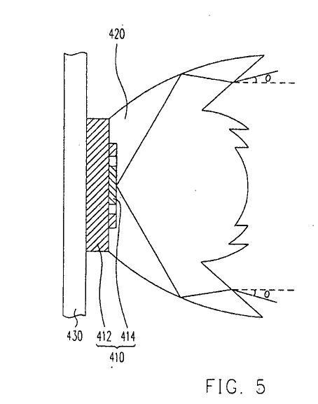

FIG. 4 is a diagram of a light emitting device according to the first embodiment of the present invention and FIG. 5 is a diagram illustrating a convergent angle of the light emitting device shown in FIG. 4. Referring to FIG. 4, a light emitting device 400 can include a light emitting semiconductor device 410 and a lens 420. The lens 420 is configured to cover the light emitting semiconductor device 410. The lens 420 can include two reflective surfaces 422, two refractive surfaces 424, and a Fresnel surface 426. Each reflective surface 422 is disposed at each side with respect to a central axis 421 of the lens 420. Each refractive surface 424 is connected with one of the reflective surfaces 422 and has a tilt included angle with respect to the central axis 421 (notated by θ₁ and θ₂ in FIG. 4). Each of the refractive surfaces 424 is extended from a place connecting with the reflective surface 422 along a direction toward the bottom of the lens 420 and/or the central axis 421. The Fresnel surface 426 is connected between the two refractive surfaces 424. In embodiments, the Fresnel surface 426 can include a plurality of adjacent refractive portions 426a, which can be symmetrically disposed at both sides with respect to the central axis 421. The orientation angle of each of the refractive portions 426a can be slightly different from each other. The refractive portions 426a are configured to direct the divergent light beam provided by the light emitting semiconductor device 410 into a nearly-parallel light beam 44.

The reflective surfaces 422 are, for example, symmetrically disposed at both sides with respect to the central axis 421. The refractive surface 424 can be, for example, symmetrically disposed at both sides respect to the central axis 421. In embodiments, each of the reflective surfaces 422 can be, for example, a curved surface. The included angle between the reflective surface 422 and the refractive surface 424 adjacent to the reflective surface 422 can be, for example, an acute angle. In embodiments, the lens 420 can be a polycarbonate (PC) lens, a polymethylmethacrylate (PMMA) lens, a resin lens, or a glass lens. The lens 420 can be fabricated, but not limited to by the present invention, for example, by injection moulding.

The light emitting semiconductor device 410 can be, for example, disposed over a circuit board 430. The light emitting semiconductor device 410 can include a packaging substrate 412 and an LED chip 414 disposed over the packaging substrate 412, wherein the LED chip 414 is electrically connected with the circuit board 430. If a current flows through the PN junction in the LED chip 414 from the circuit board 430, electrons combine with holes in the chip 414 to emit light rays 414a and 414b. The light rays 414a and 414b are emitted in various directions. A portion of the light rays 414a and 414b reach the two reflective surfaces 422 in a divergent angle roughly between about 40° and about 50°. As shown, the lens 420 is a dense medium, whereas air around the lens 420 is a non-dense medium. The refractive coefficient N1 of the lens 420 is greater than the refractive coefficient N2 of air. If the light rays 414a reaches the reflective surfaces 422 with an incident angle α and α is subject to sin α≧N2/N1, the light rays 414a can have a total internal reflection (TIR) on the two reflective surfaces 422. After the TIR, the light rays 414a are reflected and reach at least one of the refractive surface 424 and/or the Fresnel surface 426.

If the light rays 414a are reflected and reach the refractive surface 424 and/or the Fresnel surface 426 with an incident angle χ, refractions can occur at the interface between the refractive surface 424 and air and/or the interface between the Fresnel surface 426 and air. That is, after the light rays 414a reach the refractive surface 424 and/or the Fresnel surface 426 with the incident angle χ, the light rays 414a can be deflected away from the normal line of the refractive surface 424 and/or the normal line of the Fresnel surface 426. The light rays 414a can be deflected from the refractive surface 424 with a refractive angle χ′ The incident angle χ and the refractive angle χ′ are subject to:

N1/N2=sin χ/sin χ′

Since the refractive coefficient N1 is greater than the refractive coefficient N2, the refractive angle χ′ is greater than the incident angle χ. After continuous TIRs and refractions, the light rays 414a, which are originally divergent can be collected with a convergent angle θ (as shown in FIG. 5), and the convergent angle θ can be within a range between about, for example, +25° and about −25° with respect to the central axis.

In FIG. 4, having a smaller divergent angle, the light rays 414b emitted from the LED chip 414 can directly reach the Fresnel surface 426 and be deflected. As shown, the light rays 414b reach the Fresnel surface 426 with an incident angle γ, and are deflected away from the normal line of the Fresnel surface 426 for the subsequent propagation. The light rays 414b reach and are deflected from the refractive surface 426 with a refractive angle γ′. The incident angle γ and the refractive angle γ′ are subject to:

N1/N2=sin γ/sin γ′

Since the refractive coefficient N1 is greater than the refractive coefficient N2, the refractive angle γ′ is greater than the incident angle γ. As shown, the divergent light rays 414b are collected with a convergent angle θ.

By using the TIR attributed to that the incident angle α of the light rays 414a reaching the reflective surfaces 422 is greater than the critical angle, the lens 420 is capable of to desirably reflect the light rays 414a, which are emitted with a large divergent angle emitted from the LED chip 414. The light rays 414a then reach the refractive surface 424 and the Fresnel surface 426 and are deflected based on the refraction phenomena. The light rays 414a are then deflected with the convergent angle θ. In some embodiments, the light rays 414a provided by the light emitting device 400 have a smaller divergent angle. If the light emitting device 400 functions in association with a LGP, the light rays 414a and 414b emitted from the LED chip 414 can be guided to the LGP through the lens 420 substantially free from the use of other medium conversion. By reducing the use of medium conversion, the prevention of loss of light energy and/or reduction of disposing various accessory devices can be desirably achieved.

It is noted that the lens 420 can have a Fresnel surface 426 and the lens 420 can be thinner. In embodiments, the reflective surfaces 422 can be a curved surface or other shape surface. In embodiments, the reflection mechanism of the reflective surfaces 422 is not limited to the TIR. In other embodiments, a reflective material can be formed and/or coated over the reflective surfaces 422 to desirably reflect light.

In embodiments, the reflective surfaces 422 can be asymmetrically disposed with respect to the central axis 421. In other embodiments, the refractive surfaces 424 can be asymmetrically disposed with respect to the central axis 421 and a plurality of refractive portions 426a of the Fresnel surface 426 can be asymmetrically disposed with respect to the central axis 421 as well. The light rays at both sides with respect to the central axis 421 can have different divergent angles. For example, the light rays at both sides with respect to the central axis 421 can be collected with a convergent angle, which is within a range between about +25° and about −45° with respect to the central axis 421.

In addition to the above-described embodiment, more embodiments of light emitting devices are introduced hereinafter. The exemplary embodiments can achieve the desired objects described above in conjunction with FIG. 4.

### The Second Embodiment

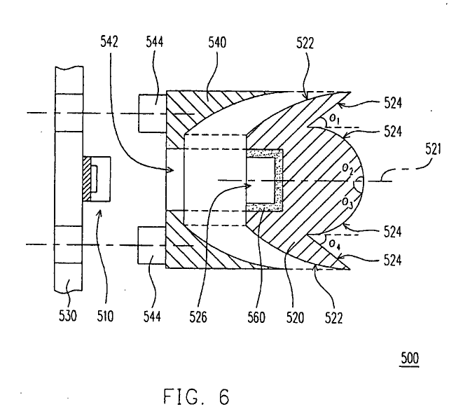

FIG. 6 is an exploded diagram of a light emitting device according to the second embodiment of the present invention. In FIG. 6, a light emitting device 500 (No element associated with reference numeral 500 is shown in FIG. 6) can include a light emitting semiconductor device 510, a lens 520, and a circuit board 530. The light emitting semiconductor device 510 can be disposed over the circuit board 530. The circuit board 530 can be a metal core printed circuit board (MCPCB). The lens 520 is configured to cover the light emitting semiconductor device 510. The lens 520 can include two reflective surfaces 522, a plurality of refractive surfaces 524, and an accommodating recess 526. The reflective surfaces 522 can be disposed at both sides with respect to a central axis 521 of the lens 520. The refractive surfaces 524 can be disposed between the two reflective surfaces 522 and respectively have a tilt included angle with respect to the central axis 521 (notated by θ₁, θ₂, θ₃ and θ₄ in FIG. 6). Two of the refractive surfaces 524 connecting with the reflective surfaces 522 respectively continuously extend from the reflective surface 522 along a direction toward the bottom of the lens 520 and/or the central axis 521. The accommodating recess 526 can be configured at the bottom of the lens 520 such that the light emitting semiconductor device 510 can be configured within the accommodating recess 526. In embodiments, light rays (not shown) emitted from the light emitting semiconductor device 510 reach the lens 520. A portion of the light rays that reach each the reflective surface 522 is reflected to at least one of the refractive surfaces 524 and is further refracted and collected with a convergent angle.

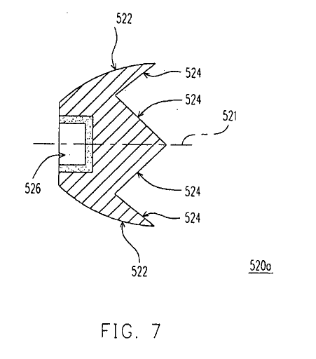

The reflective surfaces 522 can be, for example, substantially symmetrically disposed at both sides with respect to the central axis 521. The refractive surfaces 524 can be, for example, substantially symmetrically disposed at both sides with respect to the central axis 521 as well. In embodiments, each of the reflective surfaces 522 can be, for example, a curved surface. The included angle between the reflective surface 522 and the refractive surface 524 adjacent to the reflective surface 522 can be, for example, an acute angle. The remaining refractive surfaces 524 can provide, for example, a hemispherical surface. In other embodiments, the remaining refractive surfaces 524 not adjacent to the reflective surfaces 522 can provide other shapes, such as a triangle surface (referring to the lens 520a in FIG. 7). The lens 520 can be configured to provide the convergent light rays as lens 420 described above in conjunction with FIG. 4. As shown in FIG. 6, the lens 520 has a plurality of refractive surfaces 524 to replace the Fresnel surface 426 of the lens 420 (shown in FIG. 4).

In embodiments, the light emitting semiconductor device 510 can be, for example, a surface-mount light emitting device (surface-mount LED). The light emitting device 500, for example, can include a reflector 540 disposed over the circuit board 530. The lens 520 can be disposed over the reflector 540. The reflective surfaces 522 can be superimposed over the surface of the reflector 540. The material of the reflector 540 can be reflective white polycarbonate (reflective white PC), metal and/or transparent glue. In embodiments using a transparent glue, the surface of the transparent glue contacting with the reflective surfaces 522 of the lens 520 can be coated with a reflective film. In embodiments, the reflector 540 can have an opening 542 and a plurality of positioning pins 544. The light emitting semiconductor device 510 can be configured within the opening 542 and the accommodating recess 526. The positioning pins 544 can be configured within the circuit board 530. In embodiments, the positioning pins 544 can be adhered to the circuit board 530 by using glue.

The accommodating recess 526 can be configured to substantially accommodate the light emitting semiconductor device 510. The space of the accommodating recess 526 of the lens 520 can be greater than the volume of the light emitting semiconductor device 510. In embodiments, a transparent optical matching glue 560 can be applied in the gap between the light emitting semiconductor device 510 and the accommodating recess 526. The refractive index of the transparent optical matching glue 560 can be substantially equal to that of the lens 520 to desirably avoid altering the propagation direction of the light emitted from the light emitting semiconductor device 510 resulting from the gap between the light emitting semiconductor device 510 and the accommodating recess 526. The transparent optical matching glue 560 can be formed, for example, by assembling the light emitting semiconductor device 510, the reflector 540, and the lens 520 together, followed by filling the glue.

It is noted that the transparent optical matching glue 560 can be mixed with fluorescent powder. The light emitted from the light emitting semiconductor device 510 can be used to excite the fluorescent powder to radiate light rays in different colors. The light rays emitted from the fluorescent powder and the light rays emitted from the light emitting semiconductor device 510 can be blended to provide light of different colors. For example, blue light or ultraviolet light can be used to excite the fluorescent powder, such that the fluorescent powder radiates yellow light. The yellow light can be blended with the blue light emitted from the light emitting semiconductor device 510 to produce white light.

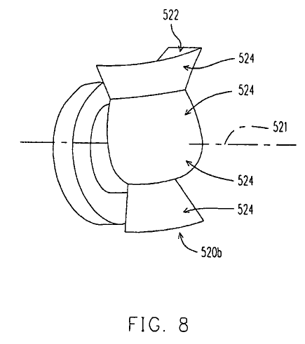

In embodiments, the reflective surfaces and the refractive surfaces of the lens can be asymmetrically disposed at both sides with respect to the central axis. As shown in FIG. 8, a lens 520b is provided. The reflective surfaces 522 can be asymmetrically disposed at both sides with respect to the central axis 521. The refractive surfaces 524 can be asymmetrically disposed at both sides with respect to the central axis 521 as well. The divergent angles of the light rays at each side with respect to the central axis 521 can be different from each other. For example, the light rays at each side with respect to the central axis 521 can be collected with a convergent angle, which is within a rang between about +25° and about −45° with respect to the central axis 521.

### The Third Embodiment

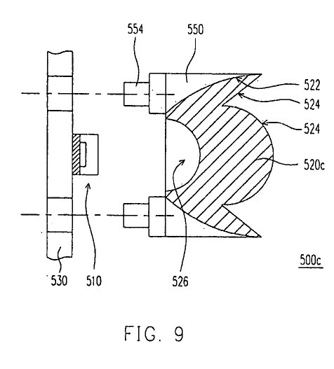

FIG. 9 is an exploded diagram of a light emitting device according to the third embodiment of the present invention. Referring to FIG. 9, a light emitting device 500c can be similar to the light emitting device 500 described above in conjunction with FIG. 6, except that the accommodating recess 526 of the lens 520c of the light emitting device 500c is a spherical recess, and the reflective surfaces 522 of the lens 520c are attached with a fixing frame 550. A plurality of positioning pins 554 can be disposed over the bottom of the fixing frame 550 and configured through a circuit board 530. In embodiments, the reflective surfaces 522 can be TIR surfaces, or a reflective layer can be applied between the reflective surfaces 522 and the fixing frame 550.

Since the accommodating recess 526 of the lens 520c is a spherical recess, the deformation of the accommodating recess 526 occurring after forming the lens 520c by using an inject moulding process can be desirably improved. A transparent optical matching glue (not shown) can be filled within the gap between the light emitting semiconductor device 510 and the accommodating recess 526. The transparent optical matching glue can be mixed with fluorescent powder. The light emitted from the light emitting semiconductor device 510 can be used to excite the fluorescent powder to radiate light with different colors.

### The Fourth Embodiment

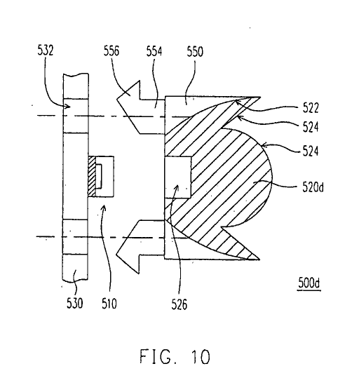

FIG. 10 is an exploded diagram of a light emitting device according to the fourth embodiment of the present invention. Referring to FIG. 10, an accommodating recess 526 of the lens 520d of the light emitting device 500d is merely large enough to substantially accommodate the light emitting semiconductor device 510. In addition, the bottom of each of the positioning pins 554 of the fixing frame 550 has a locking hook 556. In embodiments, the light emitting device 500d can be formed by, for example, assembling the light emitting semiconductor device 510 on the circuit board 530. The locking hooks 556 are configured through the openings 532 of the circuit board 530 to clamp the fixing frame 550 on the circuit board 530. After the fixing frame 550 is clamped on the circuit board 530, the light emitting semiconductor device 510 can be accommodate within the accommodating recess 526.

The embodiment is free from using glue for clamping the fixing frame 550 on the circuit board 530. If the light emitting semiconductor device 510 has a fault, the fixing frame 550 can be easily detached and replaced by other light emitting semiconductor device 510. Accordingly, the light emitting device 500d can be desirably maintained.

### The Fifth Embodiment

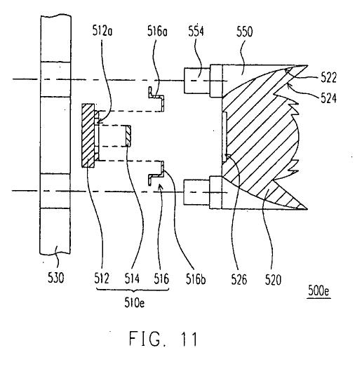

The light emitting semiconductor devices described above in conjunction with the first, second and third embodiments are exemplary surface-mount light emitting semiconductor devices. Following is a description of a light emitting semiconductor device which is not a surface-mount light emitting semiconductor device. FIG. 11 is an exploded diagram of a light emitting device according to the fifth embodiment of the present invention. Referring to FIG. 11, a light emitting device 500e of the embodiment has a light emitting semiconductor device 510e. The light emitting semiconductor device 510e can include a packaging substrate 512, an LED chip 514, and a lead frame 516. The packaging substrate 512 can be, for example, a radiator disposed over the circuit board 530. The packaging substrate 512 can have, for example, a recess 512a. The LED chip 514 can be, for example, disposed in the recess 512a. A thermal insulating glue can be applied between the LED chip 514 and the packaging substrate 512.

The lead frame 516 can include a first lead 516a and a second lead 516b. An end of the first lead 516a can be electrically connected with an electrode of the LED chip 514. Another end of the first lead 516a can be electrically connected with the circuit board 530. An end of the second lead 516b can be electrically connected with another electrode of the LED chip 514. Another end of the second lead 516b can be electrically connected with the circuit board 530. In embodiments, to prevent the lead frame 516 from electrically connecting with the packaging substrate 512, an insulator can be disposed between the lead frame 516 and the packaging substrate 512.

### The Sixth Embodiment

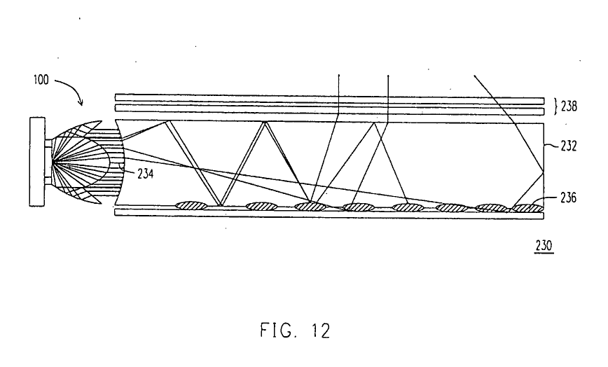

FIG. 12 is a diagram of a backlight module according to the sixth embodiment of the present invention. Referring to FIG. 12, a backlight module 230 can include a LGP 232 (light guide element) and at least one light emitting device 100. The light emitting device 100 can be disposed at a side of the LGP 232. The light emitting device 100 can be one of the light emitting devices described above in conjunction with the first-fifth embodiments. If light rays 234 are emitted from the light emitting device 100, most of the light rays 234 can reach the LGP 232 due to the smaller divergent angle (±25°) of the light rays 234. The light rays 234 can be reflected upwards by a plurality of diffusion points 236 located at the bottom of the LGP 232 and pass through an optical mechanism 238. The optical mechanism can include at least one optical film such as a diffuser, a diffusion-controller, and a bright-enhancing film to produce a uniform flat light source provided to a display panel.

In embodiments using a plate-like LGP 232, the light emitting device 100 associated with the LGP 232 can be a light emitting device having an asymmetrically-distributed divergent angle to provide a desired overall light-uniforming effect of the LGP 232.

### The Seventh Embodiment

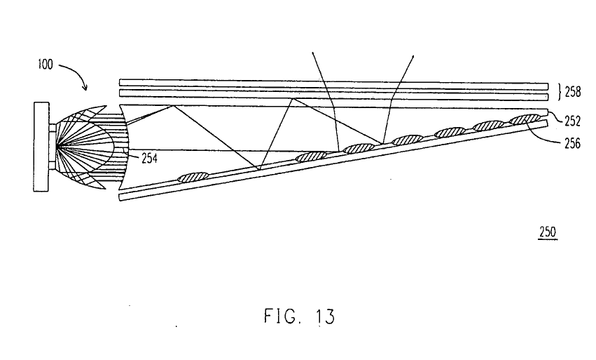

FIG. 13 is a diagram of a backlight module according to the seventh embodiment of the present invention. Referring to FIG. 13, a backlight module 250 can include a LGP 252 (light guide element) and at least a light emitting device 100 disposed at a side of the LGP 252. The LGP 252 can be a wedge-like LGP. The light emitting device 100 can be one of the light emitting devices described above in conjunction with the first-fifth embodiments. When light rays 254 are emitted from the light emitting device 100, most of the light rays 254 can reach the LGP 252 due to the smaller divergent angle (±25°) of the light rays 254. By using the structure the LGP 252 and the diffusion points 256 disposed at the bottom of the LGP 252, the light rays 254 can be reflected upwards and thereafter pass through an optical mechanism 238. The optical mechanism can include at least one optical film such as a diffuser, a diffusion-controller, and a bright-enhancing film to provide a uniform flat light source for a display panel.

### The Eighth Embodiment

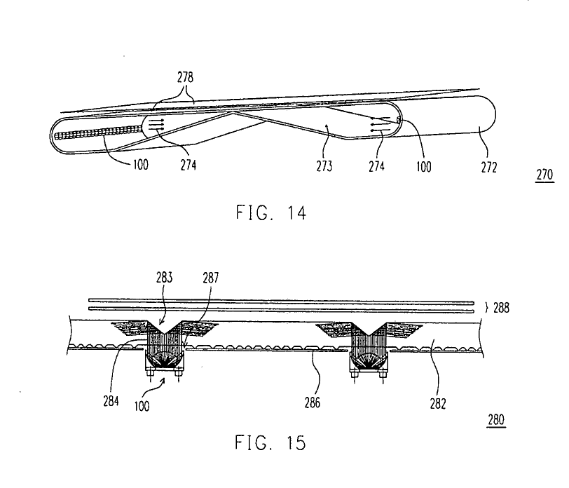

FIG. 14 is a diagram of a backlight module according to the eighth embodiment of the present invention. Referring to FIG. 14, a backlight module 270 can have a reflective sheet 272 (i.e., a light guide element). The reflective sheet 272 can have two side curved surfaces. The bottom surface of the reflective sheet 272 can have a warping structure to provide two reflective surfaces 273. The backlight module 270 has a plurality of light emitting devices 100 disposed on the two side surfaces of the reflective sheet. When light rays 274 are emitted from the light emitting devices 100, most of the light rays 274 can reach the reflective surfaces 273 due to the smaller divergent angle (±25°) of the light rays 274. The light rays 274 are reflected upwards by the reflective surfaces 273, and thereafter pass through an optical mechanism 278. The optical mechanism 278 can include at least one optical film such as a diffuser, a diffusion-controller and a bright-enhancing film to provide a uniform flat light source for a display panel.

### The Ninth Embodiment

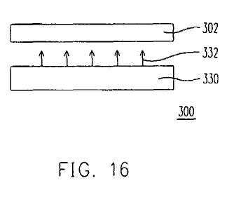

FIG. 15 is a diagram of a backlight module according to the ninth embodiment of the present invention. Referring to FIG. 15, a backlight module 280 of the embodiment includes an LGP 282 (light guide element) and at least a light emitting device 100. The light emitting device 100 can be disposed at a side of the LGP 282. The LGP 282 can be a plate-like LGP. The light emitting device 100 can be disposed under the LGP 282. A conic dent 283 can be disposed at a place corresponding to the light emitting device 100 disposed in the upper surface of the LGP 282. In embodiments, the light emitting device 100 can be one of the light emitting devices described above in conjunction with the first-fifth embodiments. The backlight module 280 can include a reflective sheet 286 disposed at the bottom of the LGP 282. The reflective sheet 286 can have an opening 287 configured at the place corresponding to the light emitting device 100.

If light rays 284 are emitted from the light emitting device 100, most of the light rays 284 can reach the LGP 282 through the opening 287 due to the smaller divergent angle (±25°) of the light rays 284. The light rays 284 can be reflected by the surface of the conic dent 283 so as to uniformly spread the light rays in the LGP 282. The reflective sheet 286 can reflect the light rays 284 upwards and thereafter the light rays 284 pass through an optical mechanism 288. The optical mechanism can include at least one optical film such as a diffuser, a diffusion-controller and a bright-enhancing film to produce a uniform flat light source provided to a display panel.

### The Tenth Embodiment

FIG. 16 is a diagram of a flat panel display according to the tenth embodiment of the present invention. Referring to FIG. 16, a flat panel display 300 can include a display panel 302 and a backlight module 330 disposed under the display panel 302. The display panel 302 can be a liquid crystal display panel (LCD panel) and the backlight module 330 can be one of the backlight modules described above in conjunction with the sixth-ninth embodiments. The backlight module 330 can provide the display panel 302 with a flat light source 332.

In summary in the present invention, the lens includes reflective surfaces and refractive surfaces by design. The light rays reaching the reflective surfaces can be reflected to guide the propagation directions of the light rays with a large divergent angle emitted from the light emitting device. The refractive surfaces can be provided to guide the light rays with a convergent angle. Since the light rays reach the LGP substantially free from multiple medium conversion processes, the backlight module employing an exemplary light emitting device can provide a desired optical usage efficiency. The desired brightness performance of the flat panel display can be achieved.

It is noted that the embodiments described above are merely exemplary. The embodiments can be separately or jointly performed to achieve a desired flat panel display.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A flat panel display, comprising:
a display panel; and
a backlight module disposed under the display panel, wherein the backlight module comprises:
a light guide element;
at least an optical film disposed over the light guide element;
at least one light emitting device disposed adjacent to a side surface of the light guide element, wherein the light emitting device comprises:
a light emitting semiconductor device; and
a lens covering the light emitting semiconductor device, wherein the lens comprises:
two reflective surfaces, each reflective surface being disposed at each side with respect to a central axis of the lens;
two refractive surfaces, each refractive surface connecting with one of the reflective surfaces and having a tilt included angle with respect to the central axis, wherein each refractive surface continuously extends from the reflective surface along a direction toward the central axis; and
a Fresnel surface configured between the refractive surfaces, wherein light rays emitted from the light emitting semiconductor device reach the lens, a portion of the light rays reaching each of the reflective surfaces is reflected to at least one of the refractive surfaces and the Fresnel surface, and the light rays reaching the at least one of the refractive surfaces are refracted with a convergent angle.

2. The flat panel display according to claim 1, wherein the light guide element is a light guide plate and the light emitting device is disposed beside the light guide plate.

3. The flat panel display according to claim 1, wherein the light guide element is a plate-like light guide plate, the light emitting device is disposed under the light guide plate, and a portion of an upper surface of the light guide plate corresponding to the light emitting device has a conic dent.

4. The flat panel display according to claim 3, wherein the backlight module further comprises a reflective sheet disposed at the bottom of the light guide plate and a portion of the reflective sheet corresponding to the light emitting device has an opening.

5. The flat panel display according to claim 1, wherein the light guide element is a reflective sheet, both side surfaces of the reflective sheet are curved surfaces, the bottom surface of the reflective sheet has a warping structure to provide two reflective surfaces, and the backlight module comprises a plurality of light emitting devices disposed on both side surfaces of the reflective sheet.

6. The flat panel display according to claim 1, wherein the reflective surfaces are symmetrically disposed at both sides with respect to the central axis, the refractive surfaces are symmetrically disposed at both sides with respect to the central axis, and a plurality of refractive portions of the Fresnel surface are symmetrically disposed at both sides with respect to the central axis.

7. The flat panel display according to claim 6, wherein the convergent angle is within a range between about +25° and about −25° with respect to the central axis.

8. The flat panel display according to claim 1, wherein the reflective surfaces are asymmetrically disposed at both sides with respect to the central axis, the refractive surfaces are asymmetrically disposed at both sides with respect to the central axis, and a plurality of refractive portions of the Fresnel surface are asymmetrically disposed at both sides with respect to the central axis.

9. The flat panel display according to claim 8, wherein the convergent angle is within a range between about +25° and about −45° with respect to the central axis.

10. The flat panel display according to claim 1, wherein the portion of light rays emitted from the light emitting device and reaching each of the reflective surfaces has a total internal reflection (TIR) on the reflective surfaces and reaches the refractive surfaces and the Fresnel surface.

11. The flat panel display according to claim 1, wherein the included angle between the reflective surface and the refractive surface is an acute angle.

12. The flat panel display according to claim 1, wherein the light rays directly reaching the refractive surfaces and the Fresnel surface are refracted and collected with the convergent angle.

13. A flat panel display, comprising:
a display panel; and
a backlight module disposed under the display panel, wherein the backlight module comprises:
a light guide element;
at least an optical film disposed over the light guide element; and
at least a light emitting device, wherein the light emitting device comprises:
a circuit board;
a light emitting semiconductor device disposed over the circuit board; and
a lens covering the light emitting semiconductor device, wherein the lens comprises:
two reflective surfaces, each reflective surface being disposed at each side with respect to a central axis of the lens;
a plurality of refractive surfaces, disposed between the reflective surfaces and respectively having a tilt included angle with respect to the central axis, wherein two of the refractive surfaces connect with the reflective surfaces and continuously extend from the respective reflective surfaces along a direction toward the central axis; and
an accommodating recess, configured at the bottom of the lens, wherein the light emitting semiconductor device is configured within the accommodating recess,
wherein light rays emitted from the light emitting semiconductor device reach the lens, a portion of the light rays reaching each reflective surface is reflected to at least one of the refractive surfaces, and the light rays reaching the at least one of the refractive surfaces are refracted and collected with a convergent angle.

14. The flat panel display according to claim 13, wherein the light guide element is a light guide plate and the light emitting device is disposed beside the light guide plate.

15. The flat panel display according to claim 13, wherein the light guide element is a plate-like light guide plate, the light emitting device is disposed under the light guide plate, and a portion of the upper surface of the light guide plate corresponding to the light emitting device has a conic dent.

16. The flat panel display according to claim 13, wherein the light guide element is a reflective sheet, both side surfaces of the reflective sheet are curved surfaces, the bottom surface of the reflective sheet has a warping structure to provide two reflective surfaces, and the backlight module comprises a plurality of light emitting devices disposed on both side surfaces of the reflective sheet.

17. The flat panel display according to claim 13, wherein the space of the accommodating recess is greater than the volume of the light emitting semiconductor device, and a transparent optical matching glue is applied in the gap between the light emitting semiconductor device and the accommodating recess.

18. The flat panel display according to claim 17, wherein the transparent optical matching glue includes fluorescent powder.

19. The flat panel display according to claim 13 further comprising a reflector, wherein the lens is disposed over the reflector, the reflective surfaces are superimposed over the surface of the reflector, the reflector has an opening and a plurality of positioning pins, the light emitting semiconductor device is configured within the opening, and the accommodating recess and the positioning pins are configured through the circuit board.

20. The flat panel display according to claim 13 further comprising a fixing frame, wherein the reflective surfaces are configured over the fixing frame, and a plurality of positioning pins are disposed at the bottom of the fixing frame and configured through the circuit board.

21. The flat panel display according to claim 20, wherein the bottom of each the positioning pin has a locking hook.

22. The flat panel display according to claim 13, wherein the reflective surfaces are asymmetrically disposed at both sides with respect to the central axis and the refractive surfaces are asymmetrically disposed at both sides with respect to the central axis.

23. The flat panel display according to claim 22, wherein the convergent angle is within a range between about +25° and about −45° with respect to the central axis.

24. The flat panel display according to claim 13, wherein the reflective surfaces are symmetrically disposed at both sides with respect to the central axis, and the refractive surfaces are symmetrically disposed at both sides with respect to the central axis.

25. The flat panel display according to claim 24, wherein the convergent angle is within a range between about +25° and about −25°.

26. A method for forming a flat panel display, comprising:
disposing a backlight module under a display panel, wherein the backlight module includes at least one light emitting device, the light emitting device includes a light emitting semiconductor device and a lens covering the light emitting semiconductor device, and the lens includes:
two reflective surfaces, each reflective surface being disposed at each side with respect to a central axis of the lens;
two refractive surfaces, each refractive surface connecting with one of the reflective surfaces and having a tilt included angle with respect to the central axis, wherein each refractive surface continuously extends from the reflective surface along a direction toward the central axis; and
a Fresnel surface configured between the refractive surfaces, wherein light rays emitted from the light emitting semiconductor device reach the lens, a portion of the light rays reaching each of the reflective surfaces is reflected to at least one of the refractive surfaces and the Fresnel surface, and the light rays reaching the at least one of the refractive surfaces are refracted with a convergent angle.
